(19) United States
(12) Patent Application Publication
(10) Pub. No.: US 2020/0289989 A1
(43) Pub. Date: Sep. 17, 2020

(54) METHOD FOR PRODUCING A PERMEABLE MATERIAL THAT FILTERS OUT HARMFUL PARTICLES AND PRODUCTS CREATED THEREFROM

(71) Applicant: TRUTEK CORP., Sommerville, NJ (US)

(72) Inventors: Ashok Wahi, Basking Ridge, NJ (US); Kanika Wahi, Basking Ridge, NJ (US); Kevin M. Bartolome, Manville, NJ (US)

(73) Assignee: TRUTEK CORP., Sommerville, NJ (US)

(21) Appl. No.: 16/889,764

(22) Filed: Jun. 1, 2020

(51) Int. Cl. B01D 67/00; B01D 46/00

(52) U.S. Cl. CPC B01D 67/0093; B01D 2239/10; B01D 67/0088; B01D 46/0032

(57) ABSTRACT

A permeable material that allows air to easily pass through the interstices in any direction. The permeable material may be a cloth, a mesh, latex, rubber, or any polymer. The material is saturated with a water and/or alcohol based solution containing either a cationic or anionic agent, a disinfecting agent, and a biocide. The solvent on the permeable material is permitted to evaporate. What remains on the permeable material is the cationic or anionic agent and the biocide. This coated material is now surrounded by an electrostatic field. The electrostatically charged material attracts oppositely charged particles and repels similarly charged particles. The particles that contain living organisms are inactivated by the biocide. The formulations have been shown to have efficacy against rhinovirus causing colds, influenza and corona viruses causing diseases such as swine flu and COVID-19, as well as other harmful airborne microscopic and sub-microscopic particles. The material may be formed into products such as face masks, unitary filters, and filtration devices. Users of these masks might want to periodically spray or otherwise apply the solution to the mask to restore its disinfecting, filtration, and biocidic properties. This would also render normally disposable cloth or surgical face masks reusable.

### CROSS REFERENCE TO RELATED PATENTS AND APPLICATIONS

This Present Application is related to my U.S. Pat. No. 8,163,802 (the '802 patent) that was issued on Apr. 24, 2012, and to my U.S. Pat. No. 9,737,497 (the '497 patent) that was issued on Aug. 22, 2017, and to my U.S. Pat. No. 9,750,706 (the '706 patent) that was issued on Sep. 5, 2017. The '802, '497, and '706 patents are incorporated herein in their entirety. This Present Application is also related to my U.S. patent application Ser. No. 12/475,690 (the '690 application) filed on Jun. 1, 2009, now abandoned, which was published as U.S. Patent Application Publication No. 2009/0235933 A1 on Sep. 24, 2009. the '690 application is incorporated herein by reference in its entirety.

### BACKGROUND OF THE INVENTION

Airborne microorganisms are a major cause of respiratory ailments in humans, causing allergies, asthma, and pathogenic infections of the respiratory tract. Airborne fungal spores are also important agents that spread diseases. Respiratory diseases cause many fatalities and are a cause of great concern. During a sneeze, millions of tiny droplets of water and mucus are expelled at a high velocity. The droplets contain viral particles and/or bacteria. This is a means of transmission of several diseases by inhaled airborne particles as follows:

TABLE 1

| VIRAL DISEASES | BACTERIAL DISEASES |
|---|---|
| (virus type in brackets) | (bacterial name in brackets) |
| Chickenpox (Varicella) | Whooping cough (Bordetella pertussis) |
| Flu (Influenza) | Meningitis (Neisseria species) |
| Measles (Rubeola) | Diphtheria |
| | (Corynebacterium diphtheriae) |
| German measles (Rubella) | Pneumonia (Mycoplasma pneumoniae, |
| | Streptococcus species) |
| Mumps (Mumps) | Tuberculosis (Mycobacterium |
| | tuberculosis) |
| Smallpox (Variola) | Anthrax (Anthracsis bacterium) |
| COVID 19 (Human Corona) | |
| SARS (Human Corona) | |

Diseases caused by environmental particulates include, but are not limited to the following:

TABLE 2

| ENVIRONMENTAL | |
|---|---|
| PARTICULATE DISEASES | SOURCE |
| Psittacosis | Dried, powdery droppings from |
| (Chlamydia psittaci) | infected birds (parrots, pigeons, etc.) |
| Legionnaire's disease | Droplets from air-conditioning |
| (Legionella pneumophila) | systems, water storage tanks, etc., |
| | where the bacterium grows. |
| Acute allergic alveolitis (various | Fungal or actinomycete spores from |
| fungal and actinomycete spores) | decomposing organic matter |
| | (composts, grain stores, hay, etc.) |
| Aspergillosis (Aspergillus | Fungal spores inhaled from |
| fumigatus, A. flavus, A. niger) | decomposing organic matter. |
| Histoplasmosis | Spores of the fungus, in old, |
| (Histoplasma capsulatum) | weathered bat or bird droppings. |
| Coccidioidomycosis | Spores in air-blown dust in desert |
| (Coccidioides immitis) | regions (Central, South and North |
| | America) where the fungus grows in |
| | the soil. |

Protecting people from inhaling harmful particles is a long felt need. Epidemics and pandemics come and go. Eventually, treatments and vaccines emerge for most. Ever since biblical times, social distancing was used to protect the general population. In more recent times, wearing face masks was used to impede the spread of disease. Rhinovirus causing colds, influenza, and corona viruses causing diseases such as swine flu and COVID-19 are examples of respiratory ailments caused by airborne particles. These viruses are spread primarily by droplets produced by an infected person coughing and sneezing or even by talking. The virus may be shed by mere breathing. Face masks worn by sick people provide some protection to others not infected. However, they provide very limited protection for the wearer.

U.S. patent literature dates back to the early part of the Twentieth Century, where patents were issued for mesh filter devices that were inserted into the nostrils. U.S. Patents were granted for these devices through the middle of the century. During the First World War, gas masks became available that neutralized the effects of chlorine, phosgene, and mustard gases. In the 1980s, nasal filters were available that also dispensed medication into the nose, e.g., antibiotics. Then construction workers began using hard masks. While these helped these workers to avoid breathing in harmful large particulate matter, such as asbestos and other debris, users complained that these masks were uncomfortable and that breathing was very difficult. An example of such masks is the N95 model that is also now used to protect medical personnel. This mask is tight fitting and contains a small permeable filter to let in air and to filter out particulate matter. The ATMOBLUE mask developed by Blue Sky Labs is far more comfortable to wear, and it provides significant protection. Like the N95, it is also a hard non-permeable mask. A portion of the mask fits tightly and comfortably over the nose and mouth using a memory foam cushion The hard plastic potion fits around the cushion. Two filters, one on either side of the nose and mouth, allow clean air to enter the breathing area. Carbon dioxide leaves the mask on the bottom.

Cloth face masks have been around for many years. So too have masks fabricated from permeable fibrous materials. These masks also allow their users to avoid inhaling large particulate matter. However, they do not protect users from inhaling allergens and pathogens. They are not effective for prevention of bacterial and viral diseases. However, to some extent, they help to prevent others from being infected by airborne pathogens by keeping droplets produced by mask users from becoming airborne. Nonetheless, prevention of spread of airborne respiratory illnesses (e.g., common cold, influenza, human corona virus causing COVID-19, etc.) is marginal.

During the early 1990s, I began development of formulations for use in restricting nasal inhalation of airborne contaminants by creating an electrostatically charged field around the nasal passages. These formulations, once applied, would repel similarly charged particles and would attract oppositely charged particles that would adhere to the formulation, by applying these formulations around the nostrils, inhalation of electrostatically charged particles was greatly reduced. This was the subject of my U.S. Pat. Nos. 5,468,488 and 5,674,481 issued on Nov. 21, 1995 and Oct. 7, 1997, respectively. These products were marketed to the public under the brand name NasalGuard®. Formulations of increased strength were the subject of my U.S. Pat. No. 6,844,005, issued on Jan. 18, 2005, where the electrostatic charge is produced by using poly (dimethyl diallyl ammonium chloride) as one of the ingredients.

In 2009, I filed U.S. patent application Ser. No. 12/475,690, the subject of which was a surgical or permeable face mask coated with a formulation having anionic or cationic properties. Here instead of these formulations being applied to the nasal region, the mask would be used to filter out charged particles and to restrict their flow into the nose and mouth. These masks would have been effective against allergic rhinitis caused by breathing in pollen and mold, but it would have done very little to prevent bacterial and viral infections. The technology to do this did not yet exist at that time. These masks were never sold.

In 2012, U.S. Pat. No. 8,163,802 was issued to me for a new formulation comprising cationic agent(s) and biocide(s), applied as a thin film around the nasal area and creating an electrostatically charged field that captured negatively charged particles and inactivated them. This formulation proved to be effective against cold and flu viral infections based on efficacy studies conducted in the United States and India. Then in 2017, I was granted U.S. Pat. Nos. 9,737,497 and 9,750,706 for formulations that would filter out and inactivate negatively charged sub-microscopic particles of a size smaller than or equal to 0.1 micron. Among other microscopic contaminants, this product is effective against most viruses. The subject formulation is currently being sold as NasalGuard® Airborne Particle Blocker®. However, although this product is effective against infection derived from nasal inhalation, it is ineffective against particles that enter the respiratory system through the mouth. Most people breathe air through their mouths 20% of the time. Others are persistent mouth breathers.

### SUMMARY OF THE INVENTION

The Present Invention is a permeable material that allows air to easily pass through the interstices in any direction. The permeable material may be a cloth, a mesh, latex, rubber, or any polymer. The cloth is saturated with a water and/or alcohol based solution containing either a cationic or anionic agent and a biocide. The water from the solution on the permeable material is permitted to evaporate. What remains on the permeable material is the cationic or anionic agent and the biocide. This coated material is now surrounded by an electrostatic field. If the field is positively charged, it will attract negatively charged particles and repel positively charged particles. If it is negatively charged, the reverse process will occur. It will attract positively charged particles and repel negatively charged particles. The particles that are attracted to the electrostatically charged material are held in place by the charge. If the particles contain living organisms, they are inactivated by the biocide.
There are no Drawings.

### DETAILED DESCRIPTION OF THE INVENTION

Given a permeable material of indefinite two-dimensional area and negligible thickness. The material has a front side and a back side. Given its permeability, air can pass through the interstices in either direction. This permeable material, such as a cloth or mesh, is sprayed with a water and/or alcohol based solution containing either a cationic or anionic agent and a biocide. The solution wets both the front side and the back side. The solution is allowed to evaporate. When dry, the material exhibits a charged electrostatic field that extends in all directions away from the front and back sides, and said charge amplitude diminishes as the square of the distance from the material. The electrostatic field will continue for an indefinite duration until something happens to dissipate the charge. Thus, the material may be cut into any shape, and delivered to or shipped to users without losing its charge. Alternatively, the permeable material may be formed into a definite shape during fabrication, thus reducing wasted material due to the cutting process.

If the solution sprayed onto or otherwise impregnated into the material contains a cationic agent, the material will attract and hold negatively charged particles from the air in the vicinity of the material. It will repel all positively charged particles. On the other hand, if the solution sprayed onto the material contains an anionic agent, material will attract and hold positively charged particles and will repel all negatively charged particles. Most harmful airborne particles possess an electrostatic charge, either positive or negative. Thus, similarly charged harmful particles are repelled and cannot pass through the material. Oppositely charged particles are attracted to the material and held in place by the fibers. The harmful particles may comprise pollen, dust, mold, and pathogens such as bacteria and viruses. The biocide contained in the solution will inactivate virtually all of the pathogens containing living organisms captured by the material, thus rendering them harmless. They may not pass through the material from one side to another in an active state.

The permeable material that is wetted by coating the solution taught in the Present Invention can be an existing permeable material. Here, the user of the face mask or filtration devices may restore the disinfection, filtration, and biocidic properties of the mask periodically as intended. Thus, a previously disposable mask may become re-usable by the method taught herein.

To accomplish the Present Invention, a formulation having at least one polyquaternary ammonium compound is prepared, such compounds, alone or together capable of creating an electrostatic field on and around a surface to which it is applied, including surfaces such as skin, textile (woven and non-woven), and hard surfaces, such as floors, walls, wood, metal, plastic, etc. The formulation is generally aqueous based, but may include non-aqueous solvents used which are compatible with the other formulation components and the application surface to which it is applied. Preferably, the formulation is an aqueous formulation. In addition to the polyquaternary ammonium compound, the composition includes at least one biocide. Furthermore, the composition may contain, but is not required to contain various thickeners, gels, colorants, emollients, humectants, fragrances, and generally other suitable components that are compatible with the end use application and the other components of the formulations.

Table 3 presents an example of a solution that may be used as a spray in the Present Invention to coat the permeable material.

TABLE 3

| | | | |
|---|---|---|---|
| | Phase/ | | |
| Ingredient | Sequence | | |
| No. | No. | Raw Materials | Percent |

PHASE A - Water @ (Ambient Temp.)

| | | | |
|---|---|---|---|
| 1 | A1 | Distilled Water | By Difference |
| 2 | A2 | Propylene Glycol | 5.0 to 15.0% |
| 3 | A3 | Benzelkonium Chloride 50% | 0.05 to 0.25% |
| | | Solution | |
| 4 | A4 | Polyquaternium-22 | 2.0 to 12.0% |

PHASE B - Ethanol @ (Ambient Temp.)

| | | | |
|---|---|---|---|
| 5 | B1 | Ethanol | 40.0 to 70.0% |
| 6 | B2 | Phenoxyethanol | 0.4% to 1.0% |
| 7 | B3 | Menthol | 0.05% to 0.30% |
| 8 | B4 | Fragrance | 0.1 to 0.5% |
| | | Total | 100 |

Incrementally add PHASE A to PHASE B - With continued stirring-mixing for 10-15 minutes

The solution in this instance contains a cationic agent, thus producing a positive charge. The solution is prepared in two parts—PHASE A (an aqueous solution) and PHASE B (an ethanol solution). PHASE A contains Polyquaternium-22, which is a polyquaternary ammonium compound, that is a cationic agent and a thickener, and benzalkonium chloride which acts as a biocide as well as a cationic agent and thickener. The polypropylene glycol is an excipient and stabilizing agent. PHASE A and PHASE B are prepared separately and then mixed as shown in the table.

Many of the ingredients utilized in my '802, '497, and '706 patents as well as those referred to in my '690 application may also be used in the solutions of the Present Invention.

Among the Ingredients of the solution there would be:
at least one quaternary thickener,
a preservative,
a conditioner,
a disinfecting agent,
a biocidic agent,
a preservative, and
a thickener,

It may also contain:
an emollient,
a decongesting agent,
a fragrance,
a humectant, and
a binder.

Ingredients as shown above and similar materials have been shown to inhibit inhalation of airborne allergens and other harmful particulate matter, and particularly to inhibit inhalation of bacterial and viral pathogens. A permeable material impregnated with a residual coating after evaporation of a wet solution will allow air to pass through purified of these harmful particulates. When held close to the nose or mouth, air passing in either direction will be substantially free of harmful pathogens.

The impregnated permeable material may be cut into various shapes and patterns. Alternatively a product fabricated from this material can be pre-formed. One use of such a product would be a conventional cloth face mask. Such a mask worn by a healthy person would be protected from inhaling airborne pathogens. In addition, such a mask worn by an infected person would protect others because his exhaled breath, once passing through the cloth, would contain dead pathogens.

The PHASE B solution shown in Table 3 contains menthol and a fragrance (e.g., sea breeze, mint, etc.). These ingredients make breathing through a mask more acceptable.

Furthermore, a person wearing such a mask need not worry about the mask fitting tightly around his or her face. Because the mask was cut from a material having a uniform electrostatic charge, air coming onto the user's face from the sides of the mask would also be free of live pathogens.

Users of these masks might want to periodically spray or otherwise apply the solution to the front side of the mask, which may have become contaminated by contact with infected individuals. This would also render normally disposable cloth or surgical face masks reusable. Furthermore, whenever the mask is washed, the solution would need to be sprayed or reapplied to the mask to recreate the electrostatic field.

However, the treated permeable material may also be used as a filter in hard masks such as the N95. It would be a particularly appropriate filter material for the ATMOBLUE mask. The ATMOBLUE mask creates a tight, comfortable fit around the nose and mouth using memory foam. The only outside air reaching the nose and mouth enters the region through the two filters, which are replaceable. The only improvement would be that the ATMOBLUE filters would be those of the Present Invention.

Another embodiment of the Present Invention would be where the permeable material is used to purify the air in a region such as a small room. Here, the permeable material would be placed into air conditioners and changed periodically. Impregnation of the material with the electrostatic coating increases particle filtration efficiency as well as bacterial and viral diminution and disinfection efficacy.

A further embodiment of the Present Invention would be the use of the permeable material in a hazmat suit or other personal protective equipment to filter out harmful particulate matter and to deactivate bacteria and viruses so as not to be inhaled by a person wearing the suit or equipment.

### GLOSSARY

1. Permeable Material—a fabricated material having interstices through which gases and some liquids may pass.
2. Indefinite Two-Dimensional Area—an undefined area that is large enough to provide sufficient material for fabrication.
3. Face Mask—a device designed to be worn by a person that covers both the nose and mouth of the person.

We claim:

1. A method for manufacturing an electrostatically charged permeable material, which filters harmful particulate matter, said method comprising:
a. wetting and impregnating the material with a liquid solution, wherein the liquid solution comprises at least one cationic or anionic agent, at least one disinfecting agent, and at least one biocidic agent; and
b. allowing or causing the liquid to evaporate, thereby leaving a residue of the at least one cationic or anionic agent and the at least one biocidic agent, wherein the residue adheres to the material,
whereby the resulting product is the electrostatically charged permeable material that filters harmful particulate matter by creating a surrounding electrostatic field that:
i. repels particulate matter that is similarly charged as the electrostatic charge of the material;
ii. attracts and holds particulate matter that is oppositely charged as the electrostatic charge of the material; and
iii. inactivates the harmful effects of the held particulate matter.

2. The method of claim 1, wherein the material is fabricated from cotton, silk, nylon, rayon, polyethylene, polymethyl methacrylate, epoxy, glass, latex, rubber, or any polymer.

3. The method of claim 1, wherein the liquid solution has an aqueous solvent.

4. The method of claim 1, wherein the liquid solution has an alcohol based solvent.

5. The method of claim 1 wherein the at least one cationic agent is a polyquaternary ammonium compound.

6. The method of claim 1 wherein the at least one cationic agent is benzalkonium chloride.

7. The method of claim 1 wherein the at least one biocidic agent is benzalkonium chloride.

8. The method of claim 1 further comprising cutting the material into one or more smaller sections.

9. The method of claim 1 further comprising forming or cutting the material into a desired shape.

10. The method of claim 1 further comprising manufacturing a face mask from the material, thereby inhibiting inhalation of the harmful particulate matter by a person wearing the mask.

11. The method of claim 10 whereby the mask is manufactured by wetting an existing non-electrostatically charged face mask.

12. The method of claim 1 further comprising inserting the material into a receptacle in a face mask and using the material to filter and deactivate the harmful particulate matter, thereby inhibiting inhalation of the harmful particulate matter by a person wearing the mask.

13. The method of claim 1 further comprising using the material to filter and deactivate airborne harmful particulate matter contained in the air.

14. The method of claim 13 further comprising filtering the air entering a confined space.

15. The method of claim 1 further comprising inserting the material into a receptacle in a hazmat suit and using the material to filter and deactivate the harmful particulate matter, thereby inhibiting inhalation of the harmful particulate matter by a person wearing the hazmat suit.

16. An electrostatically charged permeable material that filters harmful particulate matter produced using the method of claim 1.

17. The material of claim 16, wherein the permeable material is fabricated from fibers of cotton, silk, nylon, rayon, polyethylene, polymethyl methacrylate, epoxy, glass, latex, rubber, or any polymer.

18. The material of claim 16 wherein the material has a residual coating of a polyquaternary ammonium compound.

19. The material of claim 16 wherein the material has a residual coating of benzalkonium chloride.

20. The material of claim 16 formed or cut into a desired shape.

21. The material of claim 16 formed into a face mask, thereby inhibiting inhalation of the harmful particulate matter by a person wearing the mask.

22. The material of claim 16 wherein the material is produced by wetting a face mask.

23. The material of claim 16 formed into a filter that is inserted into a receptacle of a face mask, thereby inhibiting inhalation of the harmful particulate matter by a person wearing the mask.

24. The material of claim 16 formed into a filter that is inserted into a unit supplying forced air, thereby inhibiting inhalation of harmful particulate matter by those breathing the air.

25. The material of claim 16 formed into a filter that is inserted into a receptacle of a hazmat suit, thereby inhibiting inhalation of the harmful particulate matter by a person wearing the suit.

26. An electrostatically charged permeable material that filters harmful particulate matter, said material comprising a coating of at least one cationic or anionic agent, at least one disinfecting agent, and at least one biocidic agent, wherein the coating adheres to the material,
whereby the electrostatically charged permeable material filters harmful particulate matter by creating a surrounding electrostatic field that:
a. repels particulate matter that is similarly charged as the material;
b. attracts and holds particulate matter that is oppositely charged as the material; and
c. inactivates the harmful effects of the held particulate matter.

27. The material of claim 26 manufactured from cotton, silk, nylon, rayon, polyethylene, polymethyl methacrylate, epoxy, glass, latex, rubber, or any polymer.

28. The material of claim 26 wherein the material has a residual coating of a polyquaternary ammonium compound.

29. The material of claim 26 wherein the material has a residual coating of benzalkonium chloride.

30. The material of claim 26 formed or cut into a desired shape.

31. The material of claim 26 formed into a face mask, thereby inhibiting inhalation of the harmful particulate matter by a person wearing the mask.

32. The material of claim 26 wherein the material is manufactured by coating an existing mask.

33. The material of claim 26 formed into a filter that is inserted into a receptacle of a face mask, thereby inhibiting inhalation of the harmful particulate matter by a person wearing the mask.

34. The material of claim 26 formed into a filter that is inserted into a unit supplying forced air, thereby inhibiting inhalation of harmful particulate matter by those breathing the air.

35. The material of claim 26 formed into a filter that is inserted into a receptacle of a hazmat suit, thereby inhibiting inhalation of the harmful particulate matter by a person wearing the suit.
